(19) United States
(12) Patent Application Publication
(10) Pub. No.: US 2021/0378805 A1
(43) Pub. Date: Dec. 9, 2021

(54) PORTABLE ANIMAL RETAINING DEVICE

(71) Applicant: NOLA Z. GEDEON, LAKELAND, FL (US)

(72) Inventor: NOLA Z. GEDEON, LAKELAND, FL (US)

(21) Appl. No.: 17/336,926

(22) Filed: Jun. 2, 2021

Related U.S. Application Data
(60) Provisional application No. 63/034,124, filed on Jun. 3, 2020.

(51) Int. Cl. A61D 3/00; A01K 15/04

(52) U.S. Cl. CPC A61D 3/00; A61D 2003/003; A01K 15/04

(57) ABSTRACT

Animal retaining device embodiments for positioning an animal are provided. The device embodiments include a frame, multiple legs extending from the frame, and a substrate extending across the frame, wherein the substrate includes an opening for receiving a head of an animal such that its neck is maintained within the opening of the substrate during an examination, and each of said multiple legs connecting to the frame via a joint component. The retaining device decreasing potential for radiation exposure to medical professionals.

### CROSS REFERENCE TO RELATED APPLICATIONS

This application claims the benefit of U.S. Provisional Application No. 63/034,124 filed Jun. 3, 2020, incorporated by reference herein in its entirety.

### FIELD OF INVENTION

The invention relates to an animal retaining device for positioning an animal.

### BACKGROUND

During examination of an animal, the animal must be maintained in a secured and stationary position in order to provide a diagnosis and treatment plan. In some instances it is necessary to obtain radiographic images of the animal. In these instances it is preferable that the animal be held by a device to prevent or decrease radiation exposure to the medical professionals or others in the vicinity. More specifically, it may be necessary to perform an echocardiogram on an animal. In those instances, the animal must remain very still during examination.

### SUMMARY

An animal retaining device for positioning an animal includes a frame, multiple legs extending from the frame, and a substrate extending across the frame, wherein the substrate includes an opening for receiving a head of an animal such that its neck is maintained within the opening of the substrate during an examination, and each of said multiple legs connecting to the frame via a joint component. The retaining device decreasing potential for radiation exposure to medical professionals.

### BRIEF DESCRIPTION OF DRAWINGS

A more particular description briefly stated above will be rendered by reference to specific embodiments thereof that are illustrated in the appended drawings. Understanding that these drawings depict only typical embodiments and are not therefore to be considered to be limiting of its scope, the embodiments will be described and explained with additional specificity and detail through the use of the accompanying drawings in which:

FIG. 1 includes a perspective view of an embodiment of an animal retaining device in an operable position.

FIG. 2 is another perspective view of an embodiment of the retaining device in the operable position.

FIG. 3 is a bottom side view of a portion of the retaining device in an operable position.

FIG. 4 is a schematic view of another embodiment of a retaining device.

FIG. 5 is a view of a schematic of an embodiment of a retaining device in an inoperable position, folded for transport of the device within a travel bag with handle.

FIGS. 6A-6B provide a top and side view of an embodiment of the device in a folded, inoperable state.

FIG. 7 is a schematic of yet another embodiment of an animal retaining device.

### DETAILED DESCRIPTION

For the purposes of promoting an understanding of the principles and operation of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to those skilled in the art to which the invention pertains.

It is to be noted that the terms “first,” “second,” and the like as used herein do not denote any order, quantity, or importance, but rather are used to distinguish one element from another. The terms “a” and “an” do not denote a limitation of quantity, but rather denote the presence of at least one of the referenced item. Furthermore, to the extent that the terms “including,” “includes,” “having,” “has,” “with,” or variants thereof are used in either the detailed description and/or the claims, such terms are intended to be inclusive in a manner similar to the term “comprising.” The modifier “about” used in connection with a quantity is inclusive of the stated value and has the meaning dictated by the context (e.g., includes the degree of error associated with measurement of the particular quantity). It is to be noted that all ranges disclosed within this specification are inclusive and are independently combinable.

The term associated or association, as used herein, includes but is not limited to direct and indirect attachment, adjacent to, in contact with, partially or fully attached to, and/or in close proximity therewith.

The terminology used herein is for the purpose of describing particular embodiments only and is not intended to be limiting. As used herein, the singular forms “a,” “an,” and “the” are intended to include the plural forms as well, unless the context clearly indicates otherwise these terms do not denote a limitation of quantity, but rather denote the presence of at least one of the referenced item. Furthermore, to the extent that the terms “including,” “includes,” “having,” “has,” “with,” or variants thereof are used in either the detailed description and/or the claims, such terms are intended to be inclusive in a manner similar to the term “comprising.” Moreover, unless specifically stated, any use of the terms first, second, etc., does not denote any order, quantity or importance, but rather the terms first, second, etc., are used to distinguish one element from another.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. As a non-limiting example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 7.

In order to render medical services to an animal, veterinary physicians and staff are typically tasked with holding the animal in place during a medical examination which may include the taking of radiographic images. Radiography involves exposing both the animal and those surrounding the animal with harmful doses of radiation. It is crucial in some examinations to keep the animal from moving to acquire a clear image to provide for accurate diagnoses and facilitate an effective treatment plan for the injured or sick animal. In order to assist with the examination process, a device for maintaining an animal in a position is needed. In at least one embodiment described herein, a device for positioning an animal and maintaining the animal in a still position, without the need for physically restraining the animal's movement is described.

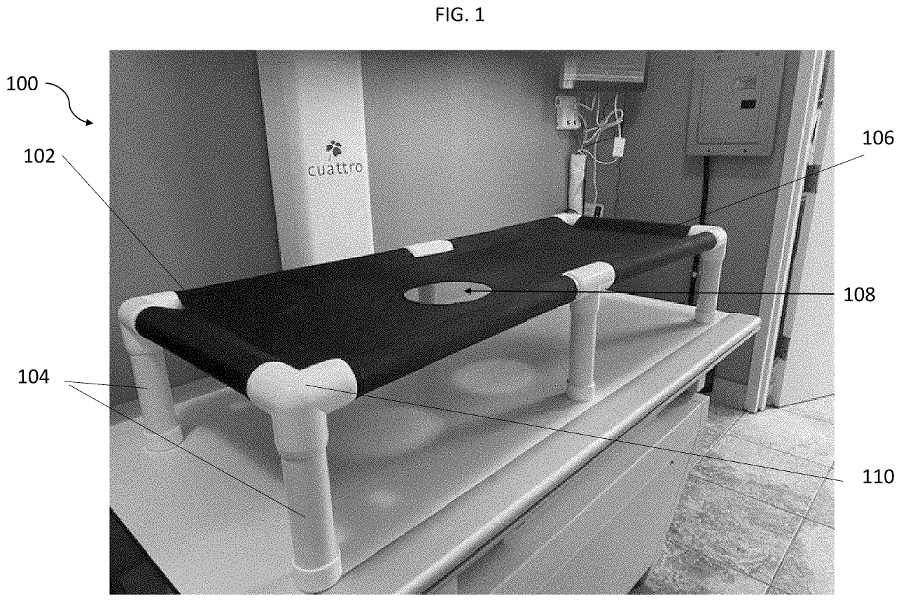

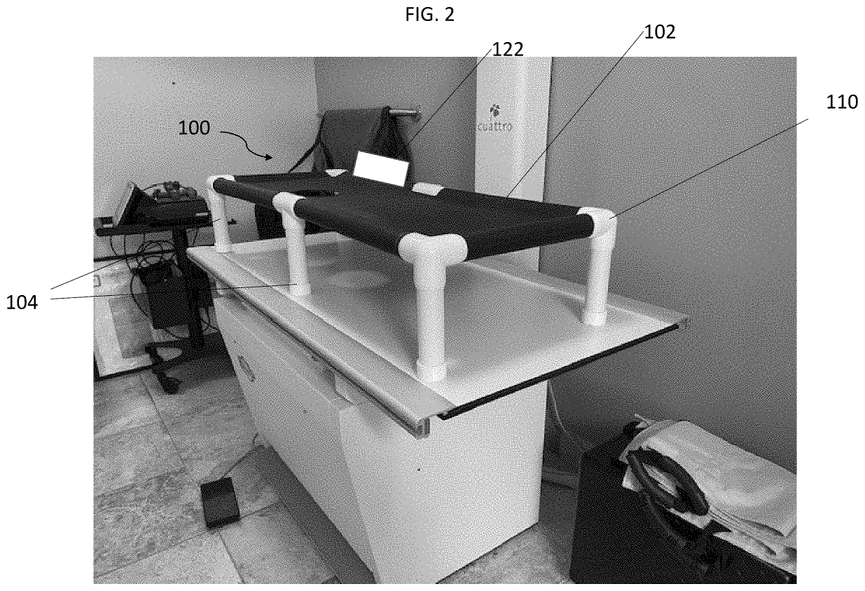

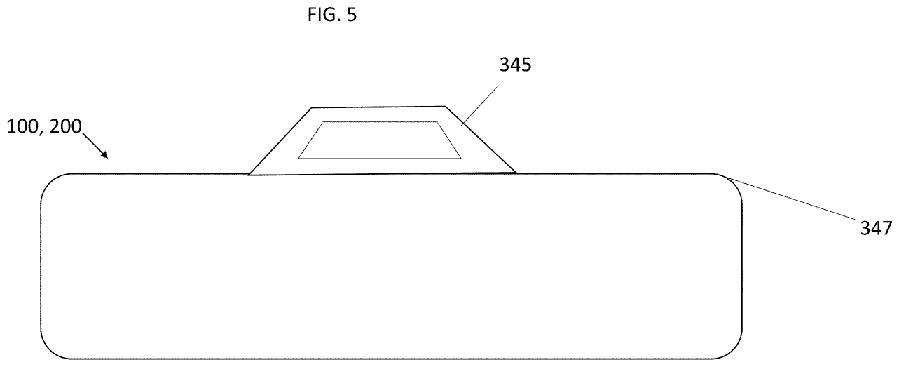

In one embodiment described herein is a portable animal retaining device 100 as shown in FIGS. 1-2 comprising a frame 102. In some examples, the frame 102 comprises a rigid support frame. The device 100 further includes multiple legs 104 for supporting the frame 102 above the floor, said legs 104 interface with the frame 102 to maintain the frame 102 a sufficient distance from the floor for at least a portion of an animal to rest between the floor and the frame level. The multiple legs 104 may extend from the frame 102. The device 100 may further include a substrate 106 extending across the frame 102. The substrate 106 may include, in some non-limiting embodiments, a flexible substrate. In other examples, the substrate 106 may include a solid platform. The substrate 106 may include an opening 108 for receiving at least a head and/or a neck of an animal, when said animal is retained within the portable animal retaining device 100. When an animal is received within the device 100, the head of the animal is placed through the opening 108 in the substrate 106 such that its legs 104 may reach the floor and its neck is placed within the opening 108 during an exanimation. In some examples, each leg 104 connects to the frame 102 via a joint component 110 to maintain the frame 102 above the floor. The legs 104 may be removable from the joint 110 in order to collapse the device for travel during non-use. Therefore, the device 100 includes an operable position and an inoperable position. In the operable position, the device 100 is extended and may receive an animal for examination. In the inoperable position as shown in FIG. 5, the device 100 is collapsed and folded for travel. The substrate 106, in some examples, may be removably attachable to the frame 102 such that it can be removed and washed during non-use of the device 100. FIG. 5 shows the foldable position of the device 100, 200 in preparation for transport or travel. FIG. 5 also shows a travel bag 347 with handle 345 for receiving and handling the device 100, 200 to provide easier transport of the device 100, 200 therewithin. Alternatively, a handle may be placed on the device 100, 200 itself, and the device 100, 200 may further include a strap or means for maintaining the device in an inoperable, collapsed state for transport in lieu of a transport bag. In one embodiment, the strap may include tread and loop closure portions, and the strap may be configured to wrap around the device to secure it in a collapsed, inoperable state. Other restraint devices may be used, including snaps or buttons, a zippered portion and/or adhesive to maintain the device in a collapsed, travel-ready state.

When an animal is retained within the device 100 the animal's head may extend above the substrate 106 and its body is beneath the substrate 106, such that its legs 104 may rest on the floor.

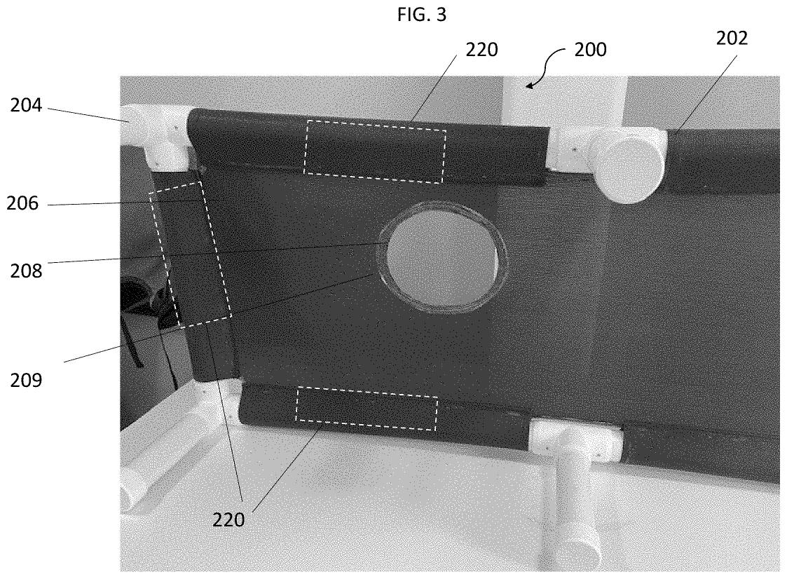

Therefore, the animal is unable to see the examination taking place beneath the substrate 106. This is beneficial for efficient examination of an animal in order to keep the animal in a relaxed state during examination. The substrate 106 serves to block the view from the animal of the tools or examination machinery being manipulated beneath the substrate 106 during the examination. FIG. 3 shows another embodiment of a retaining device 200, wherein the frame 202 may further include sub-joints 220 to allow the frame 102 to be collapsible for transportation from one location to another. In one example, the legs 204 may also be removable from the frame 202 in embodiment 200. However, in another example, the legs 204 are not removable from the frame 202, but instead the frame 202 is collapsible, so that the device 200 is more compact for travel or transport thereof. Once collapsed by folding the frame 202 at the subjoints 220, the device may take the inoperable state shown in FIG. 5. A travel bag may be used to house the device 100, 200, wherein the collapsed device 100, 200 may be placed within the travel bag 347. The travel bag 347 may include a handle 345 for facilitating transport of the device 100, 200 as shown in FIG. 5.

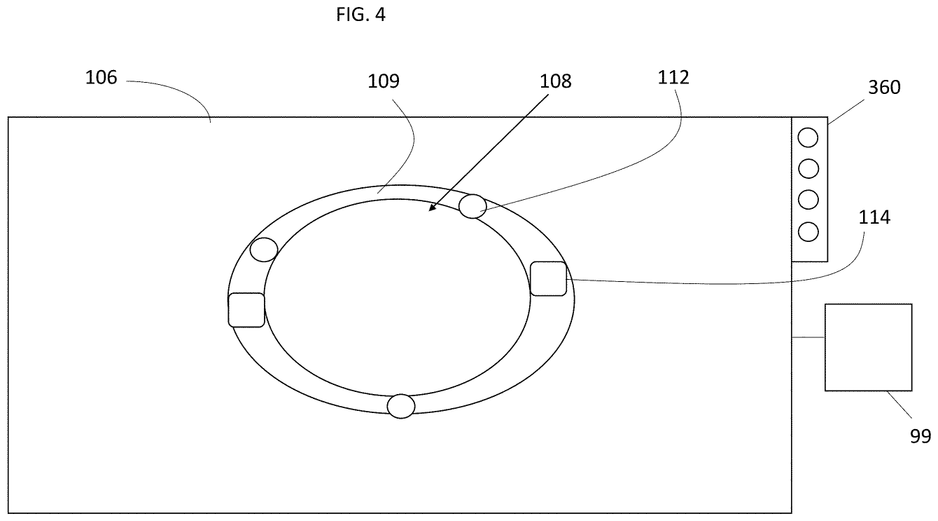

FIG. 4 provides a schematic view of the opening 108 in the substrate 106 which may include a padded perimeter 109, in one embodiment, to enhance comfort during placement and retention of the animal within the device 100. The opening 108 may include one or more heating 112 or vibrating 114 elements to comfort the animal and/or to distract the animal during the examination. The device may be connected by wired or wireless connection to a power source 99 as shown in FIG. 4 to power the heating 112, vibrating 114 and other elements of the device 100.

The heating, vibrating, and other features of the device, as well as the wired or wireless powered connection can be associated with any of the embodiments described herein.

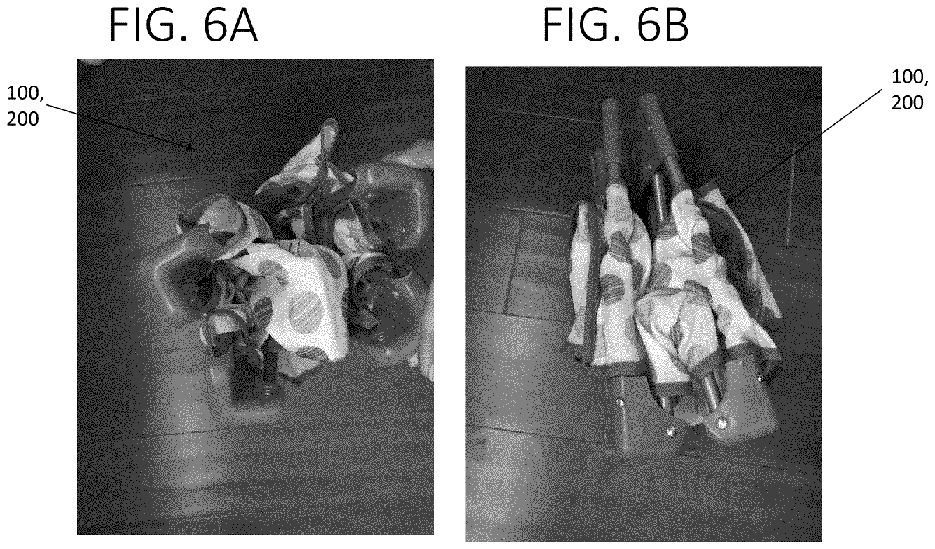

FIGS. 6A and 6B provide a top and side view, respectively, of a non-limiting embodiment of the device 100, 200, 300 shown in a collapsed, inoperable position ready for transportation. In the positions shown FIGS. 6A-6B, the device has been collapsed whether by removing the legs from the frame and/or activating the sub-joints such that it is in a folded position. The device may be transported in this manner, or further secured within a travel bag as shown in FIG. 5 for transportation.

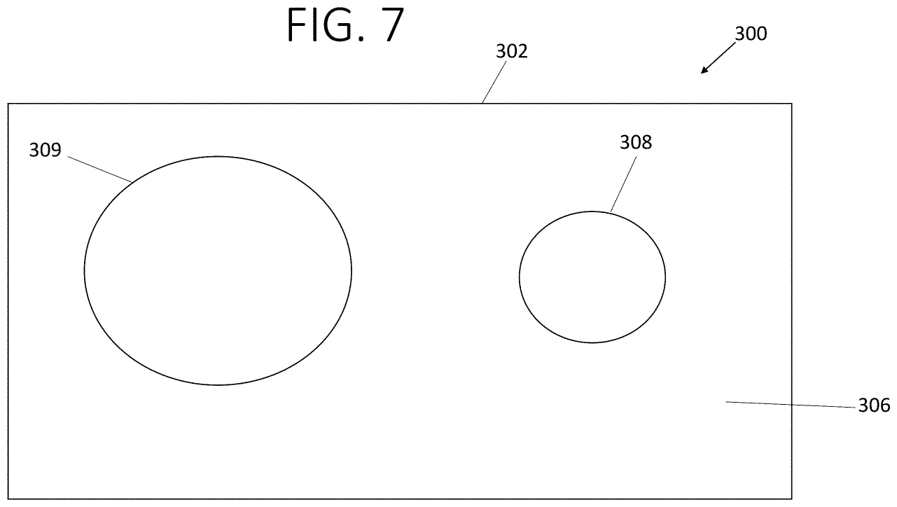

In yet a further non-limiting embodiment is an animal retaining device 300 as shown in a schematic in FIG. 7, including a frame 302. In some examples, the frame 302 may include a rigid support frame. The device 300 further includes multiple legs 304 (not shown in the schematic of

FIG. 7) for supporting the frame 302 above the floor, said legs 304 interface with the frame 302 to maintain the frame 302 a sufficient distance from the floor for at least a portion of an animal to rest between the floor and the frame level. The multiple legs 304 may extend from the frame 302. The device 300 may further include a substrate 306 extending across or between the frame 302. The substrate 306 may include, in some non-limiting embodiments, a flexible substrate. In other examples, the substrate 306 may include a solid platform. The substrate 306 may include multiple openings 308, 309 for receiving a head/neck of an animal within each opening. The embodiment 300 would allow for restraining or maintaining in position for examination multiple animals at the same time. Moreover, as shown, the openings 308, 309 may be of different diameter to accommodate animals of various sizes. As an alternative, the openings 308, 309 may be of the same diameter. When one or more animals are received within the device 300, the heads of the animals are placed through the openings 308, 309 in the substrate 306 such that its legs 304 may reach the floor and its neck is placed within the opening 308 during an exanimation. In some examples, each leg 304 connects to the frame 302 via a joint component 310 to maintain the frame 302 above the floor. The legs 304 may be removable from the joint 310 in order to collapse the device for travel during non-use as shown in various FIGS herein. The legs may further be include height adjustable legs, which may be adjustable in length to accommodate various heights of animals. The legs 302 may be formed of multiple modules securely stacked upon one another such that portions of each leg may be removed to shorten the length of the leg to accommodate the height needed to secure animals of various heights. The device 300 also includes an operable position and an inoperable position. In the operable position, the device 300 is extended and may receive an animal for examination. In the inoperable position as shown in FIGS. 5, 6A, 6B, the device 300 is collapsed and folded for travel. The substrate 306, in some examples, may be removably attachable to the frame 302 such that it can be removed and washed during non-use of the device 300. Additional or fewer openings may be provided in various embodiments of the device.

In a further embodiment, a method for positioning an animal during a medical examination may be provided. The method may include the device embodiments described herein 100, 200, 300, wherein a head and/or a neck of the animal is positioned within the opening, such that legs of the animal rest on a surface. The surface may include an examination table, or the ground or another substrate. The animal may rest comfortably while being examined and/or imaged in a still position.

Various sensors may also be included in the device embodiments described herein to detect movement, heartrate, and temperature of the animal during use of the device, for example. Other conditions may be detectable with various sensors, including conditions of the device or the animal received there within. Moreover, the device may include leads attachable to an animal to detect a condition of the animal. The device embodiments may further include or be connected to a processor for receiving and/or sending sensor input to aid in diagnosis of the animal or to provide information related to the animal. The device embodiments may include a signal output component which may include sound, lights or other visual displays to provide information or alert a user of the device to conditions sensed during use of the device. The signal output component may be associated with or connected to the power source described herein to provide power to the signal output component. Moreover, the device embodiments may be connected to radiography equipment to allow for information transfer therebetween. The device 100 may further include a platform for placement beneath the substrate 106 in a further non-limiting embodiment. The platform may be used to receive the animal thereon, and may be raised or lowered to provide adjustments for varying sizes of animals.

The device embodiments described herein may be used to support an animal during a radiography, namely, during an echocardiogram when it is important for the animal to remain still, and also crucial to avoid radiating personnel. In this manner, the animal is maintained in the device 100, reducing the need for additional personnel to hold the animal during examination.

In still further embodiments, the device may additionally include a number of straps or retaining arms which may extend from the frame 102 and surround or contact the animal to further keep the animal in place relative to the device 100, 200. These straps may be flexible or rigid arms in some non-limiting examples. The straps may attach to a collar of an animal via hook, a latch,

Velcro, a tie, or other attachment device. In non-limiting examples the rigid arms may be attached to or affixed to the animal or a jacket or collar placed on the animal to maintain the animal in one position during examination.

In some examples, an accessory component 360 for receiving and retaining one or more medical equipment accessories may be permanently or removably attached to the device 100, 200.

What is claimed is:

1. A portable animal retaining device, comprising;
a frame;
multiple legs extending from the frame;
a substrate extending across the frame, wherein said substrate comprises an opening for receiving a head of an animal such that its neck is maintained within the opening of the substrate during an examination;
each of said multiple legs connecting to the frame via a joint component.

2. The portable animal retaining device of claim 1, wherein the frame comprises at least two or more frame components, each of said two or more frame components connecting together via the joint components.

3. The portable animal retaining device of claim 1, wherein the frame comprises at least two or more interconnecting frame components, each of said frame components comprising a foldable joint such that the frame may be collapsible following use for portability of the device.

4. The portable animal retaining device of claim 1 wherein the multiple legs are adjustable to increase or decrease the distance between the floor and the frame to accommodate varying sizes of animals.

5. The portable animal retaining device of claim 1 further comprises an accessory component for receiving and retaining one or more medical equipment accessories.

6. The portable animal retaining device of claim 5, wherein the accessory component is removably attachable to the frame.

7. The portable animal retaining device of claim 3, wherein each frame component comprises a sub-joint, wherein the frame component is foldable at the sub-joint for providing a collapsible portable device.

8. The portable animal retaining device of claim 1, further including height-adjustable legs.

9. The portable animal retaining device of claim 1, further comprising multiple openings in the substrate to receive multiple animals for examination.

10. A method for positioning an animal during a medical examination comprising the device of claim 1, wherein a head and/or a neck of the animal is positioned within the opening, such that legs of the animal rest on a surface.
